(19) United States
(12) Patent Application Publication
(10) Pub. No.: US 2011/0278919 A1
(43) Pub. Date: Nov. 17, 2011

(54) CANCEL SWITCH

(76) Inventor: Tsutomu Totani, Aichi (JP)

(21) Appl. No.: 13/063,366

(22) PCT Filed: Sep. 17, 2008
(86) PCT No.: PCT/JP08/66703

§ 371 Date: Mar. 10, 2011

(30) Foreign Application Priority Data
Sep. 17, 2008 (JP) 2008-237337

(51) Int. Cl. B60L 3/00

(52) U.S. Cl. 307/10.1

(57) ABSTRACT

A cancel switch is intended for use with a vehicle equipped with an audiovisual system having a compulsory switching unit which compulsorily switches a video on a monitor screen to a still image or a navigation screen during a running condition of the vehicle. The cancel switch includes a deactivation unit deactivating the compulsory switching unit so that the video is displayed even during the running condition of the vehicle. The deactivation unit includes a proximity sensor which detects proximity of an object by a non-contact manner and a switching circuit which conducts or breaks a signal line through which a determination signal indicative of the running condition of the vehicle is transmitted.

### CROSS REFERENCE TO RELATED APPLICATIONS

This application is a U.S. national stage application of PCT/JP2008/066703 filed on Sep. 17, 2008 and is based on and incorporates herein by reference Japanese Patent Application No. 2008-237337 filed on Sep. 17, 2008.

### TECHNICAL FIELD

The present invention relates to a cancel switch for a vehicle-mounted audiovisual system provided with a compulsory switching unit which compulsorily switches a video on a monitor screen to a still image or a navigation screen during a running condition of a vehicle, and more particularly to such a cancel switch provided with a deactivation unit which deactivates the compulsory switching unit of the audiovisual system so that the video is displayed even during the running condition of the vehicle.

### RELATED ART

A vehicle-mounted audiovisual system (hereinafter, “vehicle-mounted AV system”) such as vehicle-mounted televisions, car-navigation systems, vehicle-mounted DVD reproducers, etc. generally has a function of limiting video display by forbidding video display on a monitor screen or by compulsorily switching the video display to a still image or a navigation screen such as a load map while a vehicle is in a running condition, from a standpoint of prevention of accidents such as inattentive driving.

Japanese Utility Model Registration No. JP-Y-3102335 discloses a control device provided for a vehicle-mounted television which is configured not to display a television program on air during a running condition of the vehicle. The control device allows the vehicle-mounted television to display the television program even during the running of the vehicle with consideration to safe driving.

The control device comprises a device body having a switching portion and a control portion and an operation switch which is detachably attachable to the control portion of the device body thereby to control the operation of the device body. The switching portion is provided with at least one selector switch which switches between a first state where a control signal indicative of whether or not the vehicle is running is supplied to the vehicle-mounted television and a second state which indicates that the vehicle is parked by cutting off the control signal or by another means.

The device body and the operation switch of the aforementioned control device are often attached to a front panel of dashboard, a console or the like which is reachable from a driver's seat or passenger's seat, by screws or double-sided tape. However, car design has recently employed curved surfaces, and the dashboard or the like has often employed a design composed of curved surfaces. Accordingly, it is difficult to ensure a mounting location for the aforesaid control device as a customer/user installed parts/options.

Furthermore, the device body or the operation switch attached by a double-sided tape is detached when the aforesaid control device is replaced by another or when the vehicle on which the aforesaid control device is provided is relinquished for trade-in or the like. In this case, a mark resulting from the use of the double-sided tape is sometimes left on the dashboard. It is difficult to remove the mark thereby to restore the dashboard to an original state thereof.

Furthermore, a sunburn mark is sometimes formed along a contour of the device body or the operation switch on the mounting location since the dashboard on which the device body and the operation switch are mounted is subjected to sunlight. The sunburn mark differs in the color tone from a part of the dashboard around the sunburn mark and is difficult to remove such that the dashboard cannot be restored to the original state thereof.

Additionally, a lead wire connecting between the device body and the vehicle-mounted television or the like is exposed when the device body is mounted so as to be exposed in the vehicle interior. A lead wire connecting between the operation switch and the device body is exposed when the operation switch is mounted so as to be exposed in the vehicle interior. As a result, a hand or a finger is caught by the exposed lead wire, which has a possibility of interfering with a driving operation of the driver.

### SUMMARY

Therefore, an object of the present invention is to provide a cancel switch which can be provided on a backside of the dashboard or a panel forming the console by the use of a proximity sensor thereby to prevent the interference with the driving operation of the driver.

The present invention provides a cancel switch for use with a vehicle equipped with an audiovisual system provided with a compulsory switching unit which compulsorily switches a video on a monitor screen to a still image or a navigation screen during a running condition of the vehicle, the cancel switch comprising a deactivation unit deactivating the compulsory switching unit so that the video is displayed even during the running condition of the vehicle, wherein the deactivation unit includes a proximity sensor which detects proximity of an object by a non-contact manner and a switching circuit which conducts or breaks a signal line through which a determination signal indicative of the running condition of the vehicle is transmitted.

According to the cancel switch described in claim 1, proximity of the object is detected by the proximity sensor, and the determination signal line with respect to the running condition of the vehicle is conducted or broken by the switching circuit. The proximity sensor can be mounted on the backside of a plastic panel constituting a vehicle body interior such as a front panel or a console in the vehicle interior. Accordingly, the cancel switch can be disposed on the backside of the panel forming the dashboard or the console. Consequently, the vehicle interior can be prevented from being changed even when the cancel switch is provided, whereby the unity of the design can be maintained.

Furthermore, since the cancel switch is disposed in the backside of the panel, an operating portion of the switch and a lead wire connecting between the operating portion and the switch body are not exposed in the vehicle interior. Accordingly, the driving operation can be prevented from interference since a hand or a finger is prevented from being by the operating portion and/or the lead wire.

In one embodiment, the proximity sensor is of a capacitance type. The object to be detected can be a nonmetal such as a hand or a finger since the proximity sensor is of a capacitance type. Accordingly, the switching circuit can easily be switched simply by holding the hand or the finger over a detecting portion of the proximity sensor.

In another embodiment, the switching circuit comprises a relay circuit. Consequently, the switching circuit can easily be arranged when comprising a relay circuit.

In further another embodiment, when the signal line through which the determination signal is being transmitted is conducted or cut off by the switching circuit, the switching circuit is maintained in the conducting state or the breaking state until the deactivation unit is subsequently operated. The cancel switch is configured into a self-maintaining type in which the switching circuit maintains the on-state or the off-state until subsequently operated. Consequently, the cancel switch can be turned on or off every time the hand or the finger is brought closer to the proximity sensor.

### BRIEF DESCRIPTION OF THE DRAWINGS

FIG. 1 is a perspective view of the cancel switch according to an embodiment, showing a schematic configuration of the cancel switch; and

FIG. 2 is a schematic block diagram showing a circuit arrangement of the cancel switch.

### DETAILED DESCRIPTION

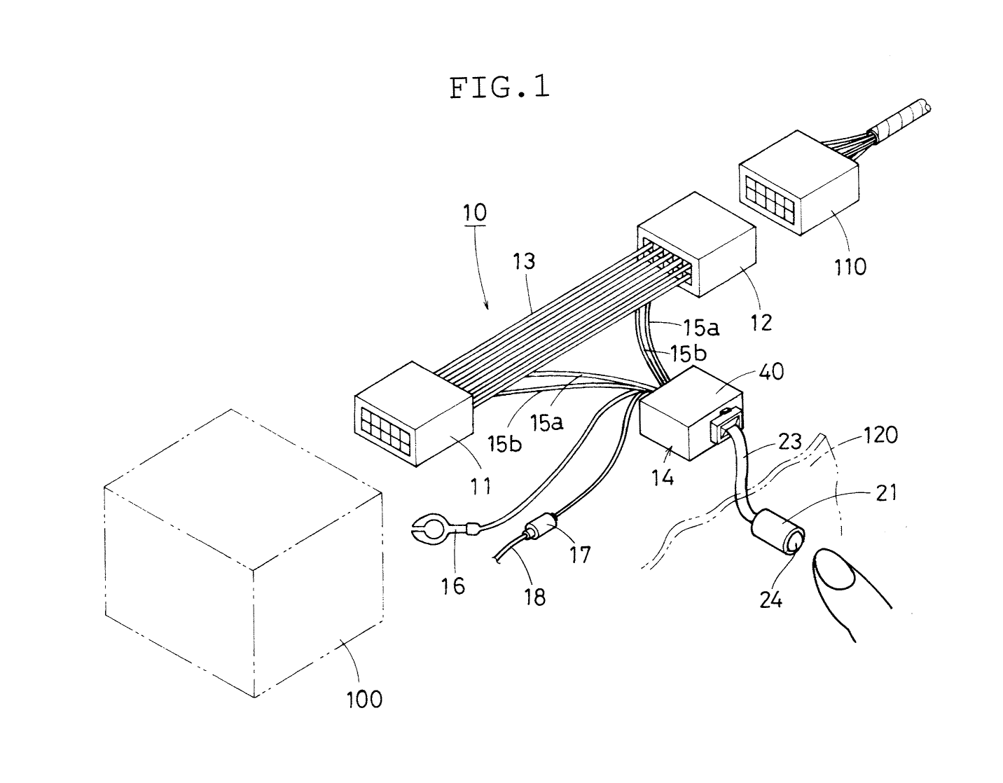

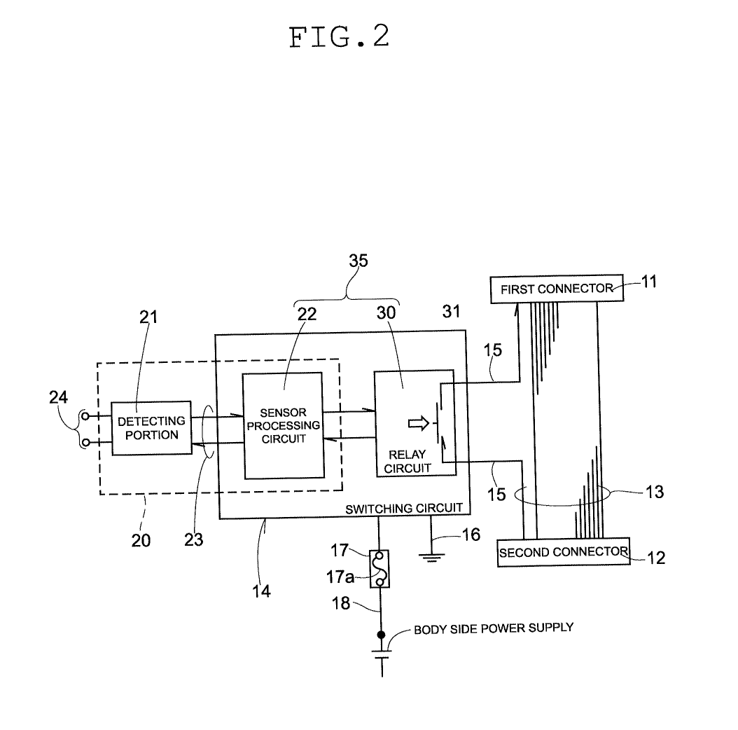

An embodiment of the cancel switch in accordance with the present invention will be described with reference to the accompanying drawings. FIG. 1 shows a schematic structure of the cancel switch and FIG. 2 is a block diagram showing the schematic circuit arrangement.

As shown in FIG. 1, the cancel switch 10 comprises a cable 13 having one of two ends provided with a first connector 11 and the other end provided with a second connector 12 and a switch body 14 provided in the middle of the cable 13. The first connector 11 is formed so as to be connectable to a control input/output terminal of a monitor device 100 composing a vehicle-mounted AV system. The second connector 12 is formed so as to be connectable to a vehicle-body side control input/output terminal 110. The cable 13 is formed by bundling a plurality of signal wires. Additionally, the vehicle-mounted AV system employed in the embodiment is a vehicle-mounted television, a vehicle-mounted theater system or a vehicle-mounted navigation system and includes a monitor device.

The signal wires composing the cable 13 comprise a power-supply line for the monitor device 100 of the vehicle-mounted AV system, an audio signal line, an image signal line from a car stereo and the like. The switch body 14 is provided in the middle of a determination signal line 15 through which a signal indicative of the determination as to whether or not the vehicle is in a running condition is transmitted. The signal transmitted through the determination signal line 15 is at least one of a global positioning system (GPS) signal, a parking brake signal, a vehicle speed detection signal and the like, all of which can detect whether or not the vehicle is running. FIG. 1 shows two determination signal lines 15, that is, a vehicle speed detection signal line 15a and a parking brake signal line 15b.

The switch body 14 comprises a detecting portion 21 of a proximity sensor 20 and a casing 40 as shown in FIGS. 1 and 2. The casing 40 encloses a substrate (not shown) on which are mounted a sensor processing circuit 22 and a relay circuit 30 provided with a relay contact. A ground wire 16 connected to the substrate is drawn out of the casing 40.

To the substrate is connected a power supply line 18 having a fuse box 17 provided in the middle thereof. The cancel switch 10 is activated by electric power supplied from a power supply line 18. A fuse 17a having a predetermined rating is enclosed in the fuse box 17. The power supply line 18 is connected to a body side power supply provided separately from a vehicle body side connector 110. However, when the cable 13 formed by bundling the signal wires includes a power supply line, electric power may be supplied to the cancel switch 10 via the fuse 17a mounted on the substrate enclosed in the casing 40.

The sensor processing circuit 22 and the relay circuit 30 constitute a switching circuit 35. A transmission line 23 connects between the detecting portion 21 of the proximity sensor 20 and the sensor processing circuit 22. Thus, the detecting portion 21 can be reduced in size and weight since the detecting portion 21 and the casing 40 are formed separately from each other.

The proximity sensor 20 is of a capacitance type and detects a variation in electric field. The detecting portion 21 has an electrode 24. A casing of the detecting portion 21 encloses a crystal (CR) oscillation circuit having the electrode 24 and a detection circuit (not shown) comprising an oscillating state detection circuit and an output circuit. A variation in electric field detected by the electrode 24 is delivered as a detection signal via the output circuit of the detection circuit. The detection signal is amplified and rectified by the sensor processing circuit 22 thereby to be converted to a control signal.

The relay circuit 30 includes at least one switch 31 as shown in FIG. 2. The relay circuit 30 mechanically opens or closes relay contacts according to the control signal transmitted from the proximity sensor 20 thereto, thereby breaking or conducting the determination signal line 15. The switching circuit 35 thus includes the relay circuit 30 switching the relay contacts off and on. However, the switching circuit 35 should not be limited to the above-described arrangement. A semiconductor switching element may be used which comprises a transistor, a field effect transistor (FET), a turn-off thyristor (GTO) or the like.

The switch body 14 is formed into a self-maintenance type and maintains a switched state when switched between on-state and off-state. As a result, the switch body 14 is maintained in on-state or off-state until subsequently operated. Accordingly, the cancel switch 10 can easily be operated. The screen of the monitor device 100 can be changed among a video image, a still image and a navigation screen every time the cancel switch 10 is operated.

The following describes the usage of the cancel switch 10 as configured above. The control input/output terminal of the vehicle-mounted AV system is fitted into the first connector 11, and the control input/output terminal 110 at the body side is fitted into the second connector 12. The detecting portion 21 of the proximity sensor 20 is thus formed with the electrode 24 in abutment with the backside of the panel 120. In this case, it is desirable that the electrode 24 be mounted so as to be directed to the surface side of the panel 120. Furthermore, the casing 40 is mounted to an out-of-side place such as a glove box, the backside of the dashboard or a lower part of driver's seat or another seat. It is more desirable that the casing 40 be mounted in the vicinity of the detecting portion 21 for the purpose of preventing the transmission line 23 from noise contamination. The panel 120 is an interior decorative material comprising a synthetic resin and constitutes the dashboard, the console or the like. The panel 120 as shown in FIG. 1 is apart of the dashboard or the like, for example.

The cancel switch 10 mounted in the above-described manner is activated when a hand or a finger is brought close to the surface side of the panel 120 on which the proximity sensor 20 is mounted. The capacitance of the electrode 24 is increased when an object comes closer to the electrode 24. The proximity sensor 20 converts a variation in the capacitance of the electrode 24 to a detection signal, delivering the signal. The proximity sensor 20 includes the CR oscillation circuit which starts or stops oscillation according to variations in the capacitance of the electrode 24. An oscillation signal delivered from the CR oscillation circuit is a detection signal of the proximity sensor 20.

Furthermore, a variation of the capacitance becomes larger as a relative permittivity is increased. The relative permittivity of water is about 80 when the relative permittivity is 1 in vacuum. Accordingly, since a capacitance type proximity sensor easily detects an object with a high water content, the proximity sensor 20 can easily detect proximity of human body with a high water content. Hence, it is desirable that a distance between the detecting portion 21 and the object be adjusted so that the proximity sensor 20 is responsive when a hand or a finger is adjacent to an opposite side of the detecting portion 21 with the panel 120 being interposed therebetween or the surface side of the detecting portion 21. As the result of such adjustment, the proximity sensor 20 can be prevented from malfunction in which the proximity sensor 20 is responsive to a hand or a finger moved in the vicinity of the surface side of the panel 120.

When the switch body 14 is switched so that the cancel switch is turned off, the switch 31 of the relay circuit 30 is conducted. In this case, a signal indicative of the running state of the vehicle is delivered. Accordingly, the compulsory switching is executed in which the video displayed by the monitor device 100 is compulsorily switched to a still image or a navigation screen. On the other hand, when the cancel switch is turned on, the switch 31 of the relay circuit 30 is broken or cut off. In this case, since the determination signal line 15 is broken, the above-described compulsory switching is not executed.

According to the above-described embodiment, the switch body 14 can be operated without touch therewith as the result of employment of the proximity sensor 20. Accordingly, the cancel switch 10 can be provided at the back surface side of the panel 120 constituting the interior of the vehicle such as the backside of the front panel or the console. Consequently, the cancel switch 10 can be installed without change in the vehicle interior and can be consealed.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

1. A cancel switch for use with a vehicle equipped with an audiovisual system provided with a compulsory switching unit which compulsorily switches a video on a monitor screen to a still image or a navigation screen during a running condition of the vehicle, the cancel switch comprising a deactivation unit deactivating the compulsory switching unit so that the video is displayed even during the running condition of the vehicle, wherein the deactivation unit includes a proximity sensor which detects proximity of an object by a non-contact manner and a switching circuit which conducts or breaks a signal line through which a determination signal indicative of the running condition of the vehicle is transmitted.

2. The cancel switch according to claim 1, wherein the proximity sensor is of a capacitance type.

3. The cancel switch according to claim 1, wherein the switching circuit comprises a relay circuit.

4. The cancel switch according to claim 1, wherein when conducting or breaking the signal line through which the determination signal indicative of the running condition of the vehicle is transmitted, the switching circuit is configured to maintain the signal line in a conducted state or a broken state until the deactivation unit is subsequently operated.

5. The cancel switch according to claim 2, wherein the switching circuit comprises a relay circuit.

6. The cancel switch according to claim 2, wherein when conducting or breaking the signal line through which the determination signal indicative of the running condition of the vehicle is transmitted, the switching circuit is configured to maintain the signal line in a conducted state or a broken state until the deactivation unit is subsequently operated.

7. The cancel switch according to claim 3, wherein when conducting or breaking the signal line through which the determination signal indicative of the running condition of the vehicle is transmitted, the switching circuit is configured to maintain the signal line in a conducted state or a broken state until the deactivation unit is subsequently operated.
